(19) United States
(12) Patent Application Publication
(10) Pub. No.: US 2024/0144207 A1
(43) Pub. Date: May 2, 2024

(54) REFLEXIVELY-ROUTED TRANSACTIONS

(71) Applicant: Bank of America Corporation, Charlotte, NC (US)

(72) Inventors: Tileshia Brenda Alford, Charlotte, NC (US); Erik Dahl, Newark, DE (US); Pratap Dande, Saint Johns, FL (US); Rahul Yaksh, Austin, TX (US); Steven Reich, Manalapan, NJ (US); Vishwanath Prasad Karra, McKinney, TX (US); Sailesh Vezzu, Hillsborough, NJ (US)

(21) Appl. No.: 17/975,699

(22) Filed: Oct. 28, 2022

(51) Int. Cl. G06Q 20/10; G06Q 40/02

(52) U.S. Cl. CPC G06Q 20/10; G06Q 40/02

(57) ABSTRACT

A system for providing a reflexively routed funds transfer is provided. The system includes a processor, and a receiver for receiving a request for a person-to-person value transfer. The request includes a request identifier. The system also includes a transmitter for transmitting the request to a shared database and a shared database. The database operates in combination with the processor to determine whether multiple targets are associated with the request identifier. When multiple targets are associated with the request identifier, the shared database operates in combination with the processor and the transmitter to notify the transfer initiator that multiple targets are associated with the request identifier, then prompts the transfer initiator to select one of the multiple targets to function as a recipient target for the value transfer. The receiver then receives a selection of one of the multiple targets to function as the recipient target. Then a router routes value transfer to the recipient target.

### FIELD OF TECHNOLOGY

Aspects of the disclosure relate to providing routing solutions for selected transactions.

### BACKGROUND OF THE DISCLOSURE

A consumer often owns multiple accounts at many different financial solutions (FIs). In some circumstances, each of the multiple accounts at the different financial solutions (FIs) are identified by the same e-mail address or mobile number.

Substantially real time funds transfer mechanisms, such as Zelle® and other systems, typically leverage e-mail addresses or mobile phone numbers to identify funds recipients.

When the user's multiple accounts are identified by a single e-mail, however, a user cannot move funds from one of the user's accounts at a first FI to another of the user's accounts at a second FI.

Accordingly, it would be beneficial to enable a user to transfer, using a substantially real-time mechanism, funds from one of the user's accounts at a first FI to another of the user's accounts at a second FI.

### SUMMARY OF THE DISCLOSURE

Methods and systems for executing a reflexively-routed transfer—i.e., a transfer from a person to the selfsame person, albeit to an account different from the transferring account—are provided.

While the systems and methods herein are described with respect to person-to-person reflexive transfer, it should be noted that a person-to-person transfer which includes a transfer to another party with multiple accounts whereby the recipient identifies multiple accounts by a single transfer mechanism identifier is also within the scope of the invention.

Methods according to the present disclosure may include receiving, from a transfer initiator, a request for a person-to-person value transfer. Such a request may include a request identifier. A request identifier may include one or more identifying e-mail addresses, mobile phone numbers, text addresses, or any other group of alpha, alpha-numeric, or numeric symbols or other suitable characters. These groups of symbols can direct a transfer of funds or other items to the recipient.

The method may include transmitting the request to a shared database, and determining, at the shared database, whether multiple targets, such as multiple accounts and/or accounts at multiple FIs, are associated with the request identifier. When multiple targets are associated with the request identifier, the method may further include notifying the transfer initiator that multiple targets are associated with the request identifier. Following the notification, the method may terminate.

Alternatively—and possibly in tandem with the notifying, the method may include prompting the transfer initiator to select one of the multiple targets to function as a recipient target for the value transfer. Preferably following the prompting, the method may include receiving from the transfer initiator a selection of the one of the multiple targets to function as the recipient target for the value transfer. In certain embodiments, the method may further include routing, either using the selection or a default setting, the value transfer to the recipient target.

It should be noted that each of the multiple targets may include a distinct account. In some embodiments, each distinct account may be associated with a different financial institution.

In addition, the prompting the transfer initiator to select one of the multiple targets to function as the recipient target for the value transfer may include presenting a selectable grid to the transfer initiator. The selectable grid may include a list of the multiple targets. The selectable grid may present, display or otherwise include an independent selection option associated with each of the multiple targets.

Upon a completion of the routing of the value transfer to the recipient target, the method may capture an audit log of the value transfer and transmit the audit log to the recipient target.

Upon a completion of the routing of the value transfer to the recipient target, the method may include capturing an audit log of the value transfer and transmitting the audit log to the transfer initiator. The transmitting the audit log to the transfer initiator may include sending an e-mail, text or other electronically transmitted message, to the transfer initiator.

The prompting the request initiator to select one of the multiple targets to function as the recipient target for the value transfer may include sending an e-mail, text or other electronically transmitted message, to the transfer initiator.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram for use in accordance with principles of the disclosure;

FIG. 2 shows another illustrative diagram for use in accordance with principles of the disclosure;

FIG. 3 shows an illustrative flow diagram in accordance with the principles of the disclosure;

FIG. 4 shows another illustrative flow diagram in accordance with the principles of the disclosure;

FIG. 5 shows yet another illustrative flow diagram in accordance with the principles of the disclosure;

FIG. 6 shows still another illustrative flow diagram in accordance with the principles of the disclosure;

FIG. 7 shows another illustrative flow diagram in accordance with the principles of the disclosure;

FIG. 8 shows yet another illustrative flow diagram in accordance with the principles of the disclosure; and

FIGS. 9A-9B show still another illustrative flow diagram in accordance with the principles of the disclosure.

### DETAILED DESCRIPTION OF THE DISCLOSURE

The technical problem faced by this application follows: a consumer that has multiple accounts with different Financial Institutions (FIs) cannot easily move money between two Zelle® (or other similarly-equipped transfer mechanism—hereinafter referred to collectively as Zelle®) participating accounts using the same e-mail address or other identifier. One way to work around this issue is to set up an ACH (Automated Clearing House) transfer for the funds to be sent to the other accounts. Yet this work around is slower, and therefore cannot be verified in substantially real time. As such—it would be advantageous to provide a more efficient and quicker solution to the above-stated problem.

Currently, the database associated with Zelle® and other transfer mechanisms only recognizes one to one matches—either through an e-mail address or mobile phone number. Both the e-mail address or mobile phone number are aligned to one Zelle® participating FI.

Systems and/or methods according to the invention preferably propose, in some embodiments, joining/appending the organization ID and recipient ID to create a unique ID for each Zelle® transfer that involves a transfer to an identifier that presents at more than one FI. If the recipient only has one other account that exists in the system, then the system can send funds or other value to that one Zelle® participating organization. If the recipient has multiple accounts with Zelle® participating FIs, the system can preferably send a notification to the recipient prompting the recipient to select the organization and/or account to which the funds should be routed. The recipient may be presented with a list of the accounts, preferably corresponding to the different FIs, enrolled in Zelle®. The user selects the participating organization/account to which the funds will be transferred. The initiator and the recipient preferably receive a notification of the successful transfer.

Part of the embodiments may also be directed to creating a query that will use the below attributes to complete a lookup to determine if the user has multiple accounts enrolled in Zelle®. It should be noted that the below-formatted query is exemplary only, and other similarly purposed queries are within the scope of the disclosure set forth herein.

Part of the embodiments may involve a query leveraging one or more of the unique IDs with the one or more of the following attributes: organizationID—a 20-byte string used to uniquely identify an organization participant in the Zelle® network; participantID—a 64-byte string used to uniquely identify an organization participant in the Zelle® network; and a partnerID—a 20-byte string used to uniquely identify a Zelle® participant in a database such as, for example, a Financial Transaction Manager (FTM) database. This partnerID preferably corresponds to the ID of the Zelle® participant in the Financial Transaction Manager (FTM) shared directory. As described above, and as referenced below, when an organization participant identifies multiple accounts with a single partnerID associated with different organizations, this may cause require resolution of issues in directing the Zelle® transfer to the appropriate account.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

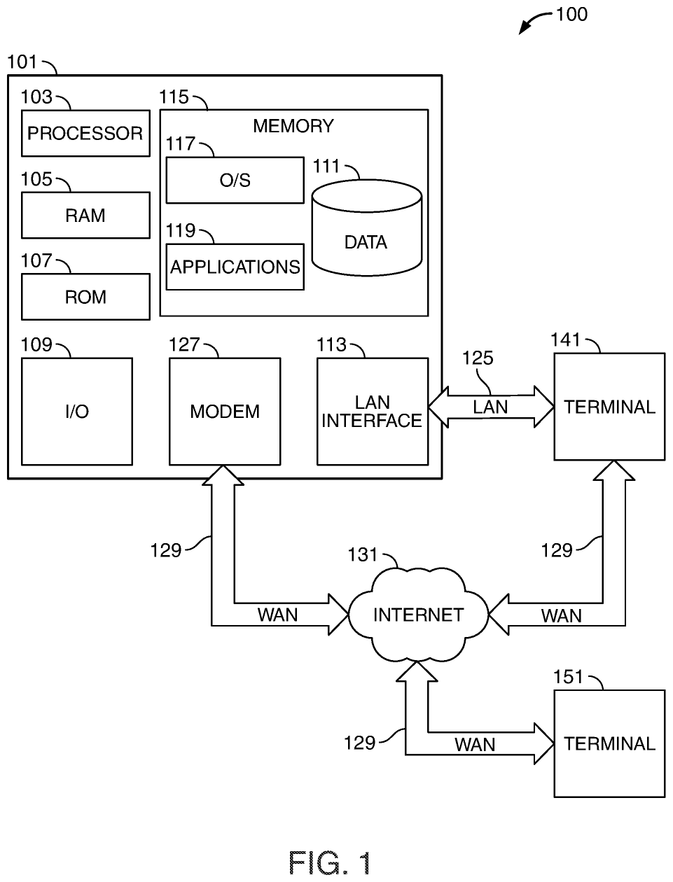

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of communications involving Artificial Intelligence (AI) as detailed herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

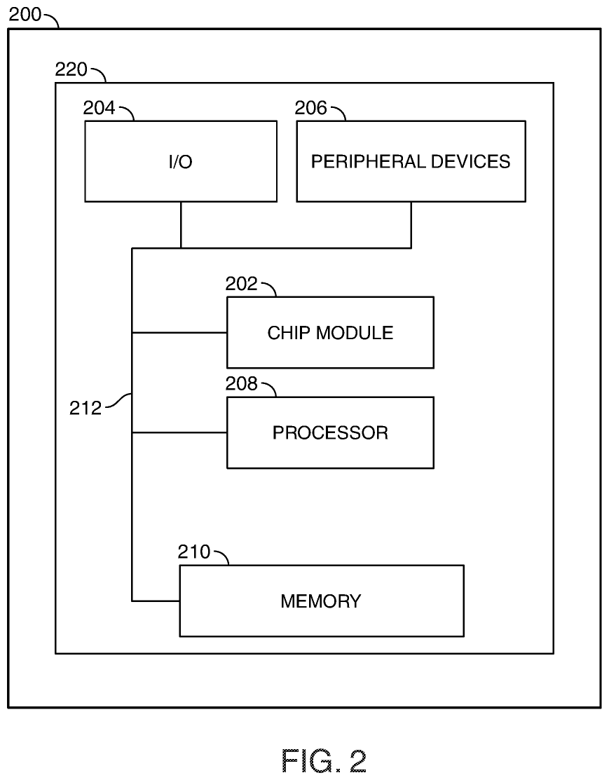

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

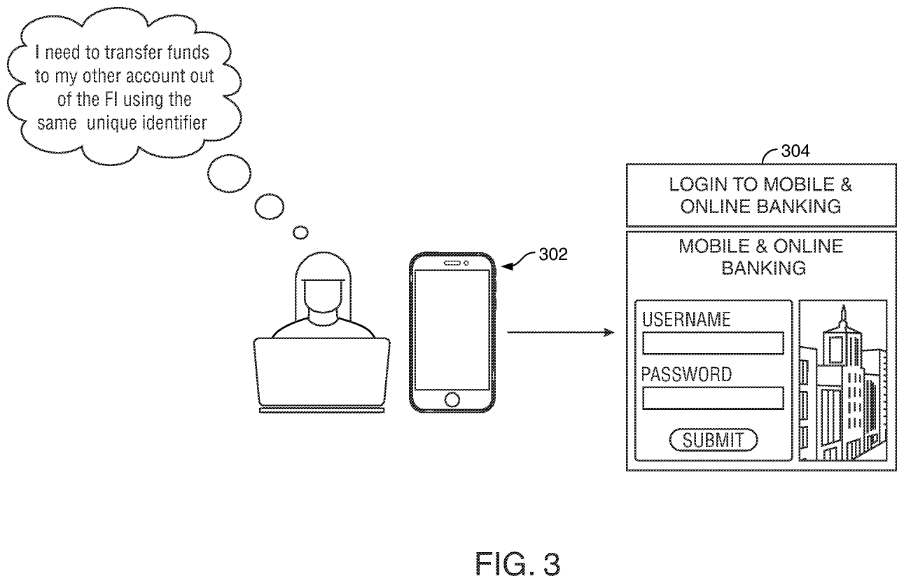

FIG. 3 shows an illustrative flow diagram in accordance with the principles of the disclosure. At 302, FIG. 3 shows a mobile banking user contemplating the technical problem of how to transfer, preferably using an immediate funds transfer mechanism such as Zelle®, Square®, or Cashapp®, funds from an account in a first FI to an account held in a second FI. The technical problem arises in this case because the account in the first FI is associated with a first unique identifier and the account in the second FI is associated with the same unique identifier.

The first step, according to the embodiments set forth herein may involve the user opening the user's mobile banking portal, as shown at 304.

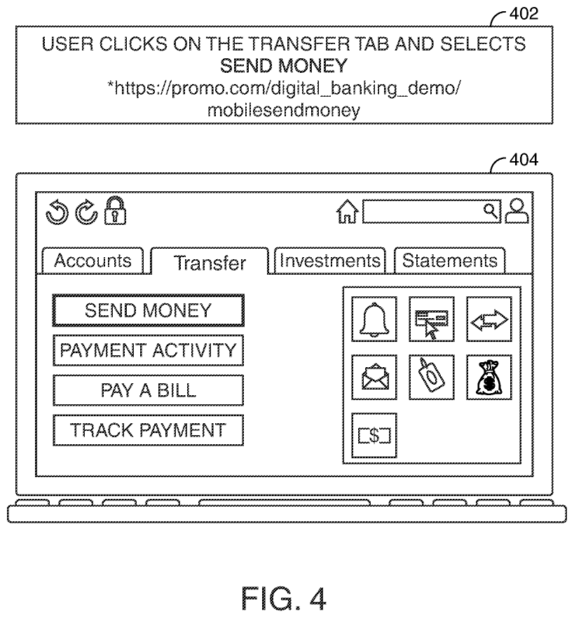

FIG. 4 shows another illustrative flow diagram in accordance with the principles of the disclosure. At 402, the user clicks on the transfer tab and selects, from the options shown in the corresponding web page 404, send money. Typically, such a selection implicates use of a real-time, or near real-time, funds transfer mechanism such as Zelle™, Cashapp™, or Square™.

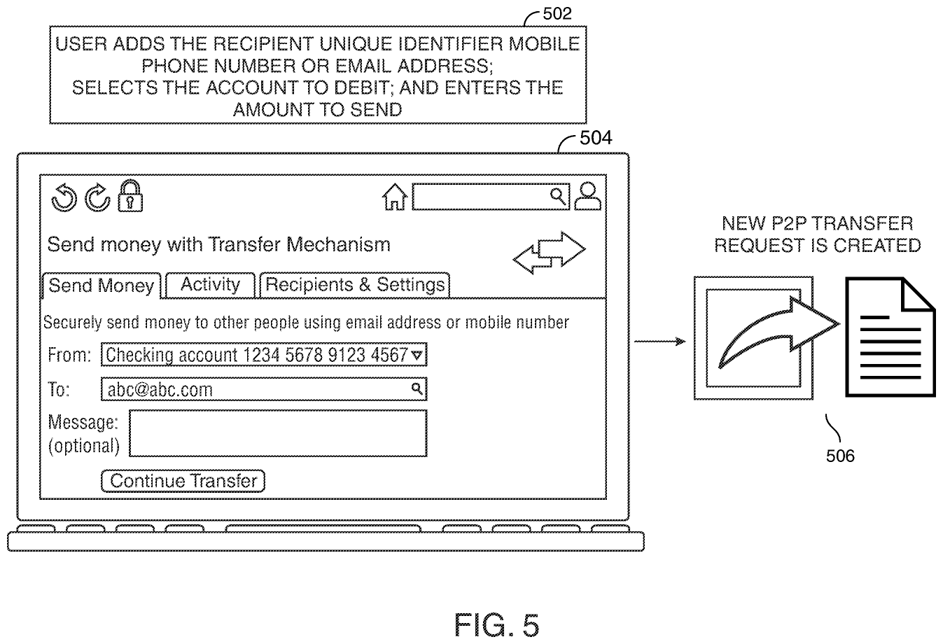

FIG. 5 shows yet another illustrative flow diagram in accordance with the principles of the disclosure. At 502, FIG. 5 shows a user adding a recipient unique identifier such as a mobile phone number or e-mail address, selecting the amount to debit and entering the amount to be sent. All these options are preferable set at screen 504. At 506, the person to person (P2P) transfer is created.

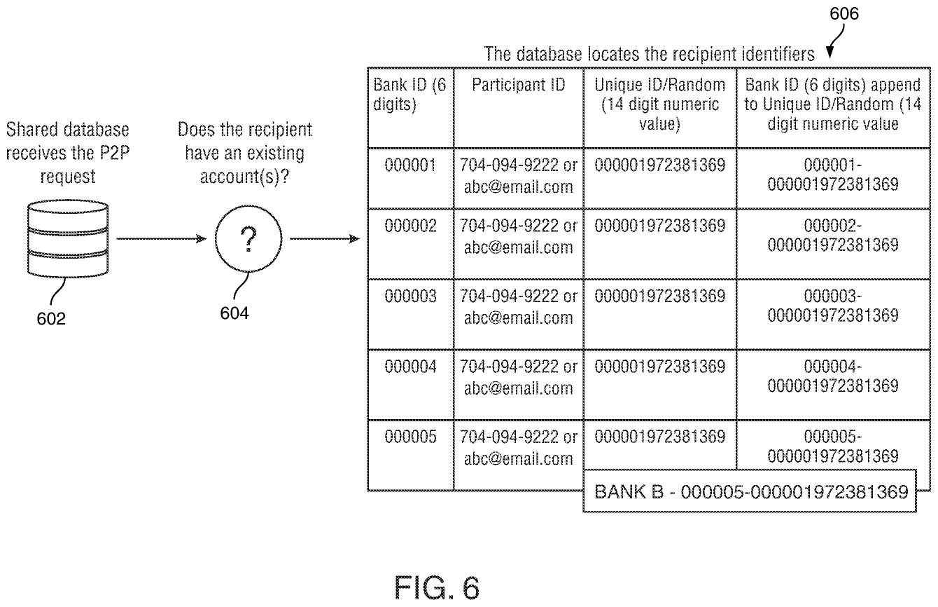

FIG. 6 shows still another illustrative flow diagram in accordance with the principles of the disclosure. FIG. 6 shows a shared database 602. Shared database 602 may be understood to refer to a database that have been returned in response to the query 604. Shared database 602 includes listings of all possible accounts into which funds can be transferred and that qualify as a response to the query at 604—i.e., does the recipient have an existing account in shared database 602.

Shared database 602 is preferably configured to receive query 604 as to whether the recipient has an existing account—i.e., an account that into which can be transferred funds via the transfer mechanism.

At 606, it has been determined that the shared database includes five (5) different accounts that qualify as responses to query 604.

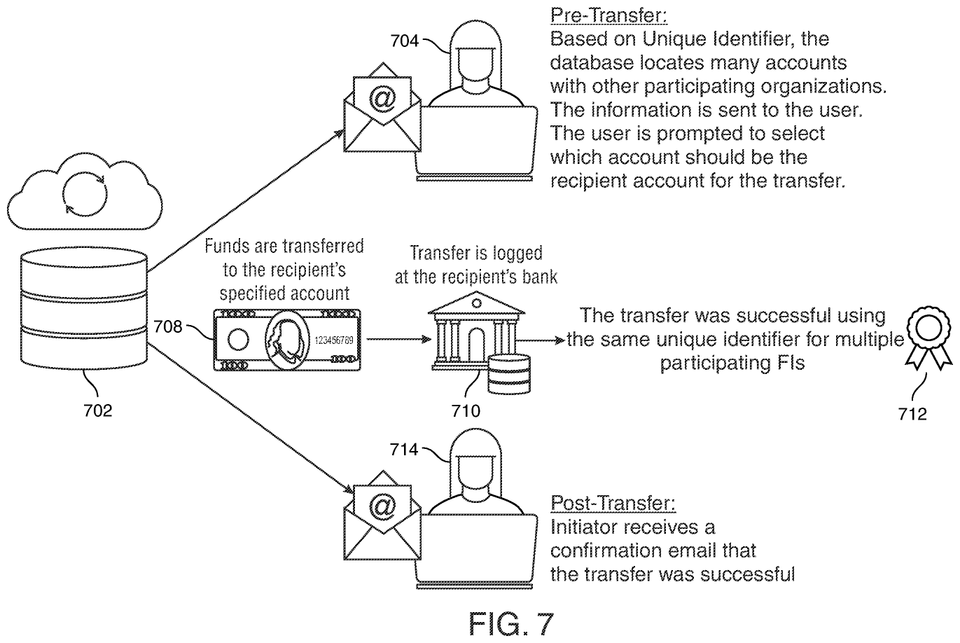

FIG. 7 shows another illustrative flow diagram in accordance with the principles of the disclosure. During the pre-transfer stage, at shared database 702, in a further and more detailed illustration of the query 604—the database queries for the accounts related to the user at other FIs. At 704, the query may return locations and information for many accounts with other organizations that participate in shared database 702. The information is sent to the user. The user is prompted to select which account should be the recipient account for the transfer.

At 708, in response to the user selecting one of the accounts at an FI specified in the selected account, funds are transferred to the recipient's selected account. At 710, the transfer is logged at the recipient's bank. Step 712 indicates that the transfer was successful using the same unique identifier for multiple participating organizations. At 714, the initiator receives a confirmation e-mail or other electronic message that the funds transfer the selected account was successful.

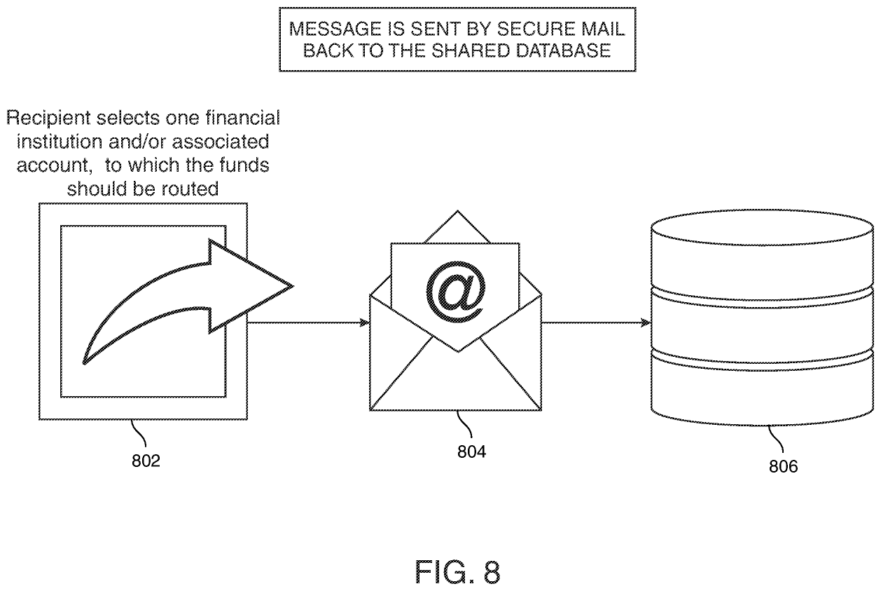

FIG. 8 shows an additional illustrative flow diagram in accordance with the principles of the disclosure. At 802, the recipient is shown to have selected one FI to which the funds should be routed. At 804, a message is sent by secure mail back to the shared database 806 for logging the completion and reportage of the transfer.

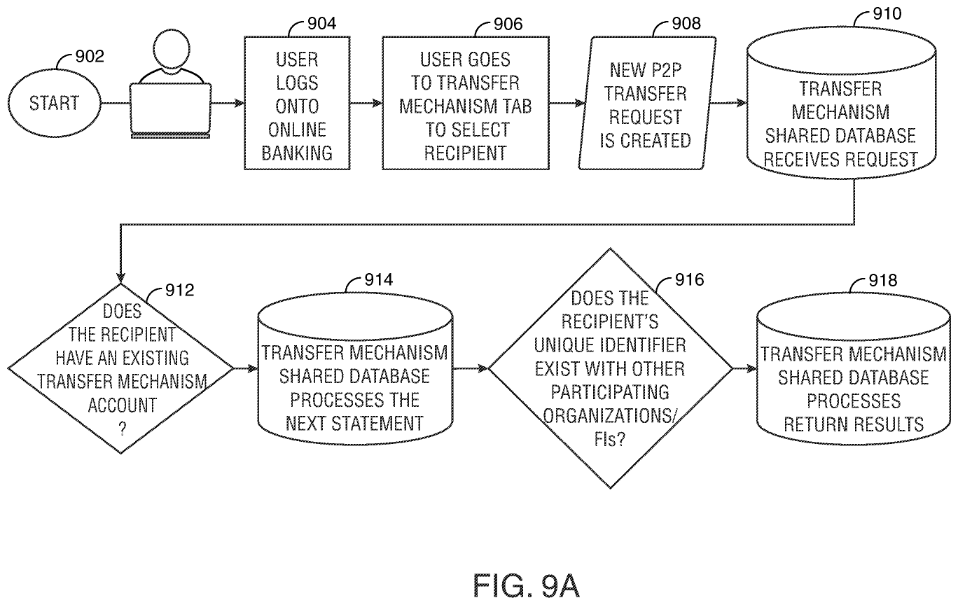

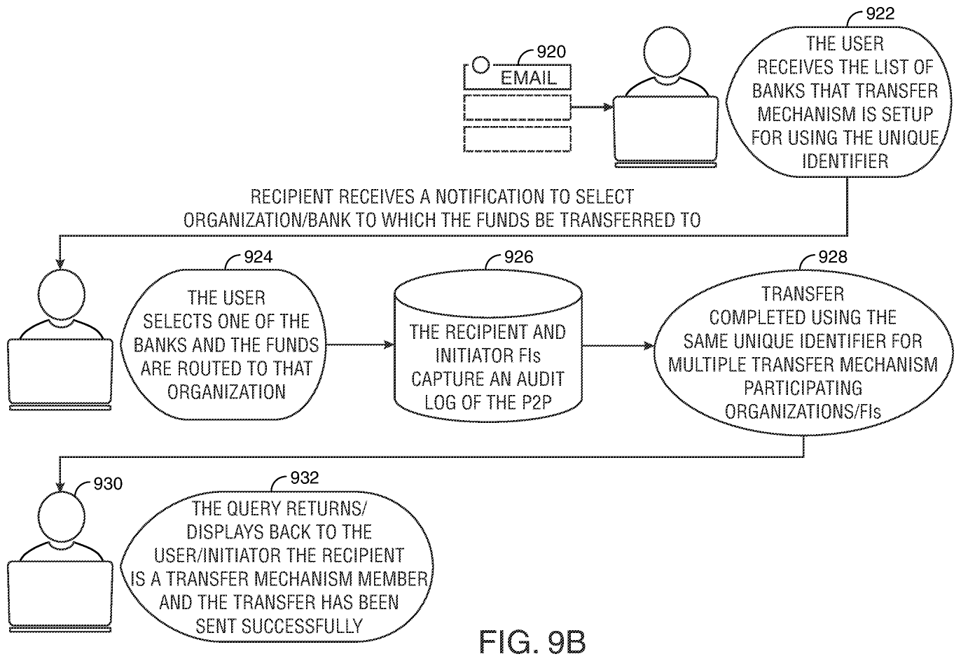

FIGS. 9A-9B show still another illustrative flow diagram in accordance with the principles of the disclosure. At 902, one illustrative flow, in accordance with the principles of the disclosure, is initiated. At 904, a user logs onto online banking. At 906, the user goes to the transfer mechanism tab to select a recipient for the real-time or near-real-time funds transfer.

At 908, a new P2P transfer request is created. At 910, the transfer mechanism shared database receives the request. At 912, the transfer mechanism queries whether the recipient has an existing transfer mechanism account. At 914, the transfer mechanism shared database processes the query. The transfer mechanism processes the query by inquiring regarding a second query—i.e., does the recipient's unique identifier exist with other participating organizations/FIs, as shown at 916.

At 918, the transfer mechanism's shared database processes query 916's return results.

In FIG. 9B, the user 920 is shown receiving an e-mail. This e-mail includes the list of FIs, and accounts located therewith, contained by the transfer mechanism that are associated with the request, as shown at 922. Query return results derived by the transfer mechanism may be sent to the user as a list of FIs, banks or other suitable institutions.

At 924—the user selects one of the FIs or accounts at the FIs. Thereafter, the funds are routed to the selected organization and/or designated account—also shown at 924.

Following the transfer, as preferably conducted by the transfer mechanism, the recipient and/or the initiator may capture an audit log of the preferably P2P (person to person—albeit self) transfer, as shown at 926. Such a transfer may be referred to herein as a reflexively-routed transfer. The transfer may have been completed, as shown at 928, using the same unique identifier that appears for accounts for multiple participating organizations. Thereafter, the system may display back to the user/initiator that the recipient is a transfer mechanism member and the transfer has been conducted successfully, as shown at 930.

Thus, systems and methods for providing REFLEXIVELY-ROUTED TRANSACTIONS. Persons skilled in the art will appreciate that the present invention can be practiced by other than the described embodiments, which are presented for purposes of illustration rather than of limitation. The present invention is limited only by the claims that follow.

What is claimed is:

1. One or more non-transitory computer-readable media storing computer-executable instructions which, when executed by a processor on a computer system, perform a method for executing a reflexively-routed transfer, the method comprising:
receiving, from a transfer initiator, a request for a person-to-person value transfer, said request comprising a request identifier;
transmitting the request to a shared database;
determining, at the shared database, whether multiple targets are associated with the request identifier;
when multiple targets are associated with the request identifier, notifying the transfer initiator that multiple targets are associated with the request identifier;
prompting the transfer initiator to select one of the multiple targets to function as a recipient target for the value transfer;
receiving from the transfer initiator, a selection of the one of the multiple targets to function as the recipient target for the value transfer; and
routing the value transfer to the recipient target.

2. The method of claim 1, wherein each of the multiple targets comprises a distinct account, each distinct account being associated with a different financial institution.

3. The method of claim 1, wherein the prompting the transfer initiator to select one of the multiple targets to function as the recipient target for the value transfer comprises presenting a selectable grid to the transfer initiator, said selectable grid that comprises a list of the multiple targets.

4. The method of claim 3, wherein the selectable grid presents an independent selection option associated with each of the multiple targets.

5. The method of claim 1, further comprising, upon a completion of the routing of the value transfer to the recipient target, capturing an audit log of the value transfer and transmitting the audit log to the recipient target based on a 20-byte string of characters associated with the recipient target.

6. The method of claim 1, upon a completion of the routing of the value transfer to the recipient target, further comprising capturing an audit log of the value transfer and transmitting the audit log to the transfer initiator.

7. The method of claim 6, wherein the transmitting the audit log to the transfer initiator further comprises sending an e-mail to the transfer initiator.

8. The method of claim 1, wherein the prompting the request initiator to select one of the multiple targets to function as the recipient target for the value transfer comprises sending a text message to the transfer initiator.

9. A system for providing a reflexively-routed funds transfer, the system comprising:
a processor for executing computer-readable instructions;
a receiver for receiving, from a transfer initiator, a request for a person-to-person value transfer, said request comprising a request identifier;
a transmitter for transmitting the request to a shared database;
a shared database that is configured to operate in combination with the processor to determine whether multiple targets are associated with the request identifier, wherein, when multiple targets are associated with the request identifier, the shared database that is further configured to operate in combination with the processor and the transmitter to notify the transfer initiator that multiple targets are associated with the request identifier and to prompt the transfer initiator to select one of the multiple targets to function as a recipient target for the value transfer;
wherein the receiver is further configured to receive, from the transfer initiator, a selection of the one of the multiple targets to function as the recipient target for the value transfer; and
a router to route the value transfer to the recipient target.

10. The system of claim 9, wherein each of the multiple targets comprises a distinct account, each distinct account being associated with a different financial institution.

11. The system of claim 9, wherein the shared database is further configured to prompt the transfer initiator to select one of the multiple targets to function as the recipient target for the value transfer by presenting a selectable grid to the transfer initiator, said selectable grid that comprises a list of the multiple targets.

12. The system of claim 11, wherein the selectable grid comprises an independent selection option associated with each of the multiple targets.

13. The system of claim 9, wherein, upon a completion of the routing of the value transfer to the recipient target, the system further is further configured to store an audit log of the value transfer.

14. The system of claim 9, wherein, upon a completion of the routing of the value transfer to the recipient target, an audit log of the value transfer is configured to be captured for distribution.

15. The system of claim 9, wherein the shared database, in conjunction with the processor, is further configured to, as part of prompt the request initiator to select one of the multiple targets to function as the recipient target for the value transfer, send an e-mail to the transfer initiator, the e-mail being retrieved based on a 20-byte string of characters associated with the recipient target.

16. The system of claim 9, wherein the prompting the request initiator to select one of the multiple targets to function as the recipient target for the value transfer comprises sending a text message to the transfer initiator.

17. A system for executing a funds transfer between a transfer initiator and a transfer recipient, the system comprising:
a processor for executing computer-readable instructions;
a receiver for receiving, from a transfer initiator, a request for a person-to-person value transfer, said request comprising a request identifier, said request identifier being based on one or more of a 20-byte string used to uniquely identify an organization participant in the Zelle® network; a 64-byte string used to uniquely identify an organization participant in the Zelle® network, and a 20-byte string of characters used to uniquely identify a Zelle® participant in a Financial Transactions Manager (FTM) database;
a transmitter for transmitting the request to a shared database;
a shared database that is configured to operate in combination with the processor to determine whether multiple targets are associated with the request identifier, wherein, when multiple targets are associated with the request identifier, the shared database that is further configured to operate in combination with the processor and the transmitter to notify the transfer initiator that multiple targets are associated with the request identifier and to prompt the transfer initiator to select one of the multiple targets to function as a recipient target for the value transfer;
wherein the receiver is further configured to receive, from the transfer initiator, a selection of the one of the multiple targets to function as the recipient target for the value transfer; and
a router to route the value transfer to the recipient target.
